(19) United States
(12) Patent Application Publication
(10) Pub. No.: US 2025/0385614 A1
(43) Pub. Date: Dec. 18, 2025

(54) THREE-PHASE RESONANT CONVERTER AND CONTROL METHOD THEREOF

(71) Applicant: Delta Electronics (Shanghai) CO., LTD., Shanghai (CN)

(72) Inventors: Yuesen GUO, Shanghai (CN); Kai DONG, Shanghai (CN); Jinfa ZHANG, Shanghai (CN)

(73) Assignee: Delta Electronics (Shanghai) CO., LTD., Shanghai (CN)

(21) Appl. No.: 19/223,366

(22) Filed: May 30, 2025

(30) Foreign Application Priority Data
May 31, 2024 (CN) 2024107061584

(51) Int. Cl. H02M 3/335; H02M 3/00

(52) U.S. Cl. CPC H02M 3/33571; H02M 3/01

(57) ABSTRACT

The present disclosure provides a three-phase resonant converter, including: a primary switching unit, including three primary switching bridge arms, wherein each primary switching bridge arm includes a first primary switch and a second primary switch, and a bridge arm midpoint formed between the first primary switch and the second primary switch; a voltage conversion unit, including three primary windings and three secondary windings, wherein a first terminal of each primary winding is electrically connected to the bridge arm midpoint of the corresponding primary switching bridge arm, and second terminals of the three primary windings are electrically connected to a common node; a resonant unit, including three resonant circuits; a secondary rectifier unit, including three rectifier circuits; and at least one bypass capacitor, electrically connected between the common node and an input terminal of the primary switching unit.

### CROSS REFERENCE

The present application is based on and claims priority to Chinese Patent Application No. 2024107061584, filed on May 31, 2024, the entire contents of which are incorporated herein by reference.

### TECHNICAL FIELD

The present disclosure relates to the technical field of converters, and in particular to a three-phase resonant converter and a control method thereof.

### BACKGROUND

A typical Alternating Current-Direct Current (AC-DC) power supply consists of two stages: a front-stage AC-DC converter and a back-stage DC-DC converter. Inductor-Inductor-Capacitor (LLC) resonant converters, which are widely used in the DC-DC stage, can achieve zero-voltage switching (ZVS) for primary switches and zero-current switching (ZCS) for secondary switches,. In practical applications, when the input source of the power supply fails, the output voltage of the LLC resonant converter must remain within a specific voltage range for a period of time (i.e., a hold-up time), such as 10 ms.

During an input source failure, the LLC resonant converter operates by discharging a bulk capacitor of the front stage. The discharge energy of the bulk capacitor is determined by its capacitance value, voltage and the voltage gain of the LLC resonant converter. For single-phase LLC resonant converters, existing solutions in the prior art typically focus on hardware or software modifications to extend the output voltage hold-up time during such failure, for example, increasing the capacitance value of the bulk capacitor, or adopting a leading phase-shifting control strategy. Furthermore, since the leading phase-shifting control strategy requires no additional devices and only modifies the driving signals, this control strategy provides significant comparative advantages and is widely adopted for extending the output voltage hold-up time in single-phase LLC resonant converters during input source failures. However, for the existing three-phase LLC resonant converters, three resonant circuits on the primary side are connected to a common node, whose potential is fluctuating. If the leading phase-shifting control strategy is directly applied to the existing three-phase LLC resonant converters, the output voltage gain may not be sufficiently enhanced. Consequently, the leading phase-shifting control strategy cannot be directly applied to the existing three-phase LLC resonant converters to stabilize the output voltage within a specific hold-up time during input source failures.

Therefore, it is necessary to develop a three-phase LLC resonant converter and a control method thereof to solve the problems faced in the prior art.

It should be noted that the information disclosed in the Background section above is only for enhancing the understanding of the background of the present disclosure, and thus may include information that does not constitute prior art known to those of ordinary skill in the art.

### SUMMARY

According to an aspect of the present disclosure, there is provided a three-phase resonant converter, including:
a primary switching unit, including three primary switching bridge arms connected in parallel, wherein each primary switching bridge arm includes a first primary switch and a second primary switch connected in series, and a bridge arm midpoint formed between the first primary switch and the second primary switch;
a voltage conversion unit, including three primary windings and three secondary windings, wherein a first terminal of each primary winding is electrically connected to the bridge arm midpoint of the corresponding primary switching bridge arm, and second terminals of the three primary windings are electrically connected to a common node;
a resonant unit, including three resonant circuits, wherein each resonant circuit includes a resonant inductor and a resonant capacitor, and each primary winding of the voltage conversion unit is connected in series with the resonant inductor and the resonant capacitor of the corresponding resonant circuit;
a secondary rectifier unit, including three rectifier circuits with output terminals connected in parallel, wherein each input terminal of the three rectifier circuits is electrically connected to a respective secondary winding; and
at least one bypass capacitor, electrically connected between the common node and an input terminal of the primary switching unit.

According to another aspect of the present disclosure, there is provided a method for controlling a three-phase resonant converter, which is applicable to the aforementioned three-phase resonant converter, wherein each rectifier circuit includes a first rectifier switching unit and a second rectifier switching unit, and the method includes:
controlling at least one secondary switch of the first rectifier switching unit of each rectifier circuit to be activated before the first primary switch of the corresponding primary switching bridge arm by a first preset duration, and controlling at least one secondary switch of the second rectifier switching unit to be activated before the second primary switch of the corresponding primary switching bridge arm by the first preset duration.

It should be noted that the above general description and the following detailed description are merely exemplary and explanatory and should not be construed as limiting of the disclosure.

### BRIEF DESCRIPTION OF THE DRAWINGS

The drawings herein are incorporated in and constitute a part of the specification, illustrate embodiments consistent with the present disclosure, and together with the description serve to explain principles of the present disclosure. Apparently, the drawings in the following description are only some embodiments of the present disclosure. For those of ordinary skill in the art, other drawings may be obtained based on these drawings without paying any creative effort.

FIG. 1 shows a schematic structural diagram of a three-phase resonant converter according to the present disclosure;

FIG. 2 shows a schematic structural diagram of a three-phase resonant converter according to an embodiment of the present disclosure;

FIG. 3 shows a schematic structural diagram of a three-phase resonant converter according to another embodiment of the present disclosure;

FIG. 4 shows a schematic structural diagram of a three-phase resonant converter according to yet another embodiment of the present disclosure;

FIG. 5 shows a schematic structural diagram of a three-phase resonant converter in the prior art, considering a distributed capacitor;

FIG. 6 shows a schematic structural diagram of the three-phase resonant converter shown in FIG. 5 with a bypass capacitor of the present disclosure added;

FIG. 7a shows a schematic diagram of a single-phase simplified topology structure corresponding to FIG. 5;

FIG. 7b shows a schematic diagram of a single-phase simplified topology structure corresponding to FIG. 6;

FIG. 8 shows a schematic structural diagram of a three-phase resonant converter according to some embodiments of the present disclosure;

FIG. 9 shows a schematic diagram of a single-phase simplified topology structure corresponding to FIG. 8;

FIG. 10 shows a conduction timing diagram of each switch shown in FIG. 9;

FIG. 11 shows another conduction timing diagram of each switch shown in FIG. 9;

FIG. 12 shows a schematic structural diagram of a three-phase resonant converter according to some other embodiments of the present disclosure;

FIG. 13 shows a schematic diagram of a single-phase simplified topology structure corresponding to FIG. 12;

FIG. 14 shows a conduction timing diagram of each switch shown in FIG. 13;

FIG. 15 shows a schematic diagram of a single-phase simplified topology structure corresponding to FIG. 1; and

FIG. 16 shows a schematic diagram of a method for controlling a three-phase resonant converter according to the present disclosure.

### DETAILED DESCRIPTION

Example embodiments will now be described more fully with reference to the accompanying drawings. However, the example embodiments can be implemented in a variety of forms and should not be construed as being limited to examples set forth herein; rather, these embodiments are provided so that the present disclosure will be more complete and comprehensive so as to convey the idea of the example embodiments to those skilled in this art.

The terms “include/comprise”, “contain”, “have”, etc. used in the present disclosure are all open-ended, meaning including but not limited to. In addition, “electrically connected”, “connected” and “coupled” as used herein may refer to two or more elements making direct physical or electrical contact, which may be directly connected or indirectly connected through an intermediate element.

In addition, the drawings are merely schematic representations of the present disclosure and are not necessarily drawn to scale. The same reference numerals in the drawings denote the same or similar parts, and the repeated description thereof will be omitted. Some of the block diagrams shown in the figures are functional entities and do not necessarily correspond to physically or logically separate entities. These functional entities may be implemented in software, or implemented in one or more hardware modules or integrated circuits, or implemented in different networks and/or processor devices and/or microcontroller devices.

Some embodiments of the present disclosure are described in detail below in conjunction with the accompanying drawings. In the absence of conflict, the following embodiments and features in the embodiments may be combined with each other, and the same or similar concepts or processes may not be described in detail in some embodiments.

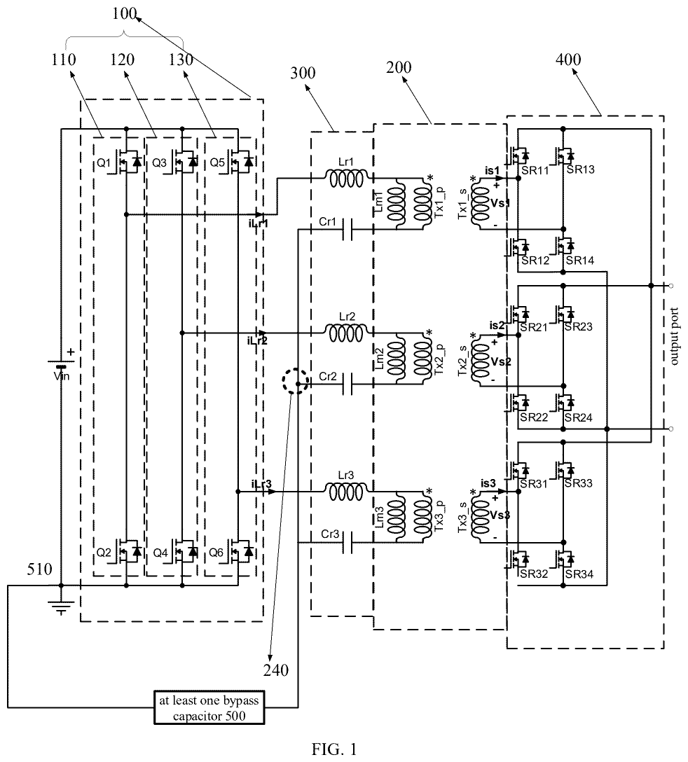

As shown in FIGS. 1 to 4, embodiments of the present disclosure provide a three-phase resonant converter, including:
a primary switching unit 100, including three primary switching bridge arms (110, 120, 130) connected in parallel, wherein each primary switching bridge arm includes a first primary switch and a second primary switch connected in series, and a bridge arm midpoint formed between the first primary switch and the second primary switch, for example, the primary switching bridge arm 110 includes the first primary switch Q1 and the second primary switch Q2, the so-called bridge arm midpoint refers to a connection node A1 between the first primary switch Q1 and the second primary switch Q2;
a voltage conversion unit 200, including three primary windings (210, 220, 230) and three secondary windings (211, 221, 231), a first terminal of each primary winding is electrically connected to the bridge arm midpoint of the corresponding primary switching bridge arm, and second terminals of the three primary windings are electrically connected to a common node 240, for example, the first terminal of the primary winding 210 is electrically connected to the bridge arm midpoint A1, and the second terminal of the primary winding 210 is electrically connected to the common node 240;

a resonant unit 300, including three resonant circuits (310, 320, 330), each resonant circuit includes a resonant inductor and a resonant capacitor, and each primary winding of the voltage conversion unit 200 is connected in series with the resonant inductor and the resonant capacitor of the corresponding resonant circuit, for example, the resonant inductor Lr1 and the resonant capacitor Cr1 of the resonant circuit 310 are connected in series with the primary winding 210;
a secondary rectifier unit 400, including three rectifier circuits (410, 420, 430) with output terminals connected in parallel, wherein each input terminal of the three rectifier circuits is electrically connected to a respective secondary winding, for example, the rectifier circuit 410 is electrically connected to the secondary winding 211; and
at least one bypass capacitor 500, electrically connected between the common node 240 and an input terminal of the primary switching unit 100. As shown in FIG. 1, the at least one bypass capacitor 500 is electrically connected between the common node 240 and a second input terminal of the primary switching unit 100 (i.e., a negative terminal of an input voltage Vin, which is also a primary ground terminal). In other embodiments, the at least one bypass capacitor 500 may also be electrically connected between the common node 240 and a first input terminal of the primary switching unit 100 (i.e., a positive terminal of the input voltage Vin).

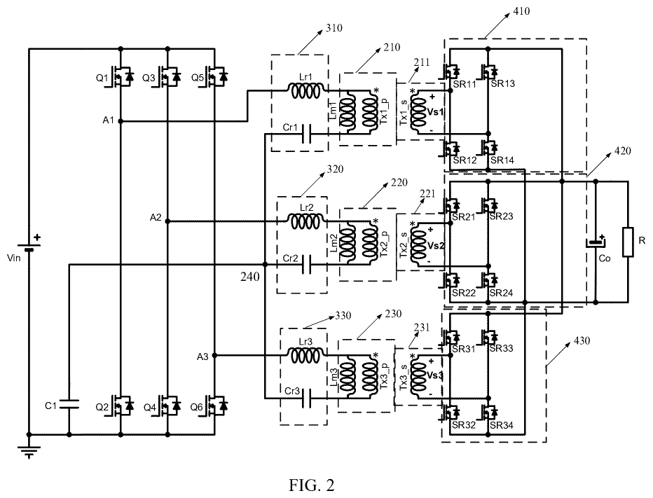

In some embodiments of the present disclosure, the at least one bypass capacitor 500 includes a first bypass capacitor, a first terminal of the first bypass capacitor is electrically connected to the common node 240, and a second terminal of the first bypass capacitor is electrically connected to the input terminal of the primary switching unit. FIG. 2 is a three-phase resonant converter provided by an embodiment of the present disclosure. As shown in FIG. 2, the first terminal of the first bypass capacitor C1 is electrically connected to the common node 240, and the second terminal of the first bypass capacitor C1 is electrically connected to the second input terminal of the primary switching unit 100. FIG. 3 is a three-phase resonant converter provided by another embodiment of the present disclosure. A circuit structure of the three-phase resonant converter shown in FIG. 3 is similar to a circuit structure shown in FIG. 2, with the difference that in this embodiment, the second terminal of the first bypass capacitor C2 is electrically connected to the first input terminal of the primary switching unit 100.

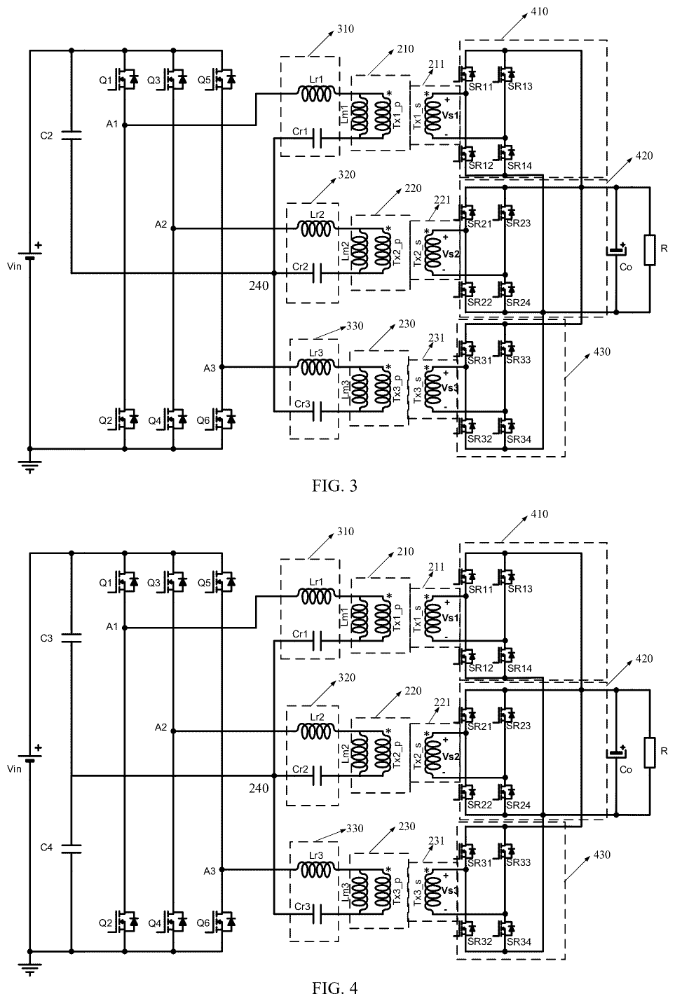

In some embodiments of the present disclosure, the at least one bypass capacitor 500 further includes a second bypass capacitor, a first terminal of the second bypass capacitor is electrically connected to the common node 240, and a second terminal of the second bypass capacitor is electrically connected to another input terminal of the primary switching unit 100. FIG. 4 is a three-phase resonant converter provided by yet another embodiment of the present disclosure. In this embodiment, the three-phase resonant converter includes a first bypass capacitor C3 and a second bypass capacitor C4. A first terminal of the first bypass capacitor C3 is electrically connected to the common node 240, and a second terminal of the first bypass capacitor C3 is electrically connected to the first input terminal of the primary switching unit 100. A first terminal of the second bypass capacitor C4 is electrically connected to the common node 240, and a second terminal of the second bypass capacitor C4 is electrically connected to the second input terminal of the primary switching unit 100.

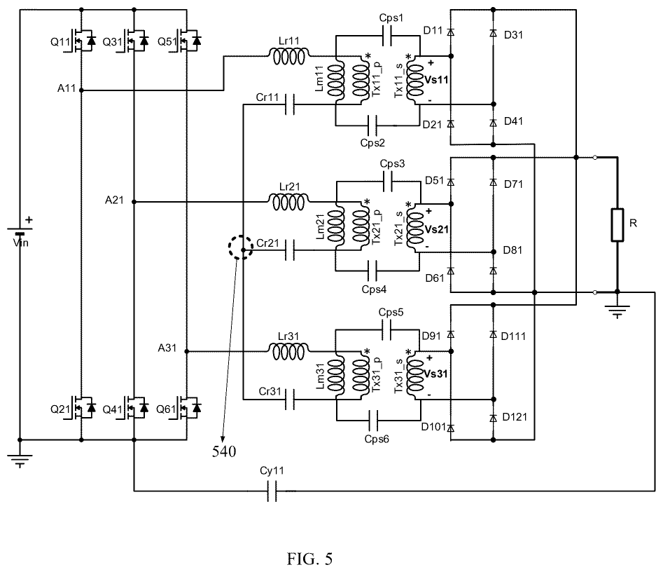

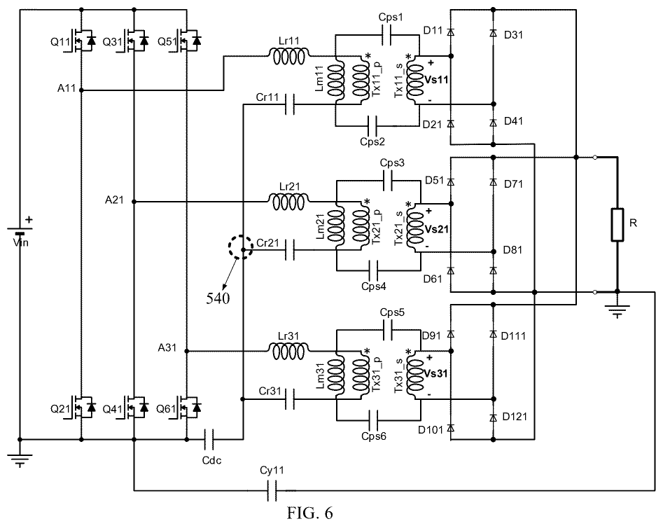

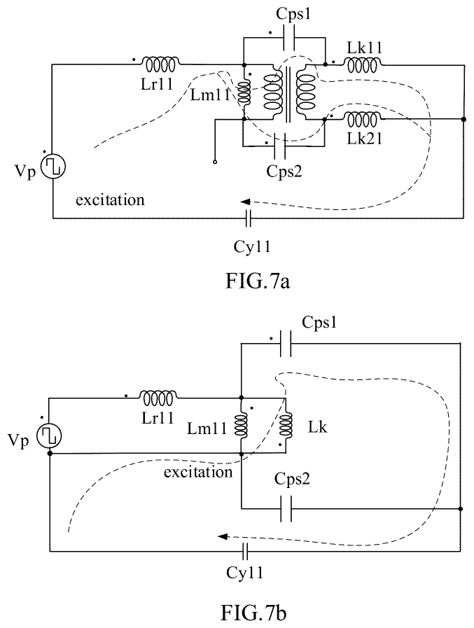

Furthermore, the three-phase resonant converter provided by embodiments of the present disclosure can also effectively filter out the common-mode noise. FIG. 5 is a circuit structure diagram of a three-phase resonant converter in the prior art, considering a distributed capacitor. Since the secondary rectifier circuit does not affect the common-mode noise analysis, the secondary rectifier circuit is simplified to take the diode rectification as an example for explanation. As shown in FIG. 5, three secondary windings of a transformer are each connected to three rectifier circuits in a one-to-one correspondence, and output terminals of the three rectifier circuits are connected in parallel. In addition, a terminal of the load is grounded, and a distributed capacitor Cy11 is connected between the grounded terminal of the load and the negative terminal of the input voltage. FIG. 6 is a circuit structure diagram of the three-phase resonant converter shown in FIG. 5 with the bypass capacitor in the present disclosure added. As shown in FIG. 6, compared with the circuit structure shown in FIG. 5, the difference is that a first bypass capacitor Cdc is connected in series between a node 540 and the negative terminal of the input voltage. By performing the simplified analysis, according to a current flow direction, on a circuit of a phase in the circuits shown in FIG. 5 and FIG. 6, schematic diagrams of a single-phase high-frequency equivalent topology structure as shown in FIGS. 7a and 7b can be obtained, where FIG. 7a corresponds to FIG. 5, and FIG. 7b corresponds to FIG. 6, Cps1 and Cps2 are parasitic capacitances between primary and secondary sides of the transformer. As shown in FIG. 7a, for the high-frequency equivalent circuit without the first bypass capacitor, a common-mode noise loop is shown as a dotted line, which passes through an excitation source Vp, a resonant inductor Lr11, the parasitic capacitance and the leakage inductance Lk11, and then returns to the primary side through the distributed capacitor Cy11 of the ground loop. The excitation source Vp is a voltage generated by the primary switching unit to convert the input voltage Vin, that is, a voltage to the ground at the bridge arm midpoint of the primary switching unit, and its rising speed is a rising speed of a voltage across the primary switch. When the first bypass capacitor Cdc is provided, as shown in FIG. 7b, since the first bypass capacitor Cdc is equivalent to a short circuit for the high-frequency common-mode noise, the common-mode noise loop is shown by the dotted line, which returns to the primary side through the leakage inductance Lk and the distributed capacitor Cy11. The excitation source is an excitation inductance Lm11. Since a rising speed of a voltage across Lm11 is generally slower than the rising speed of the voltage across the primary switch, the solution of adding the bypass capacitor in embodiments of the present disclosure is beneficial to reducing the common-mode noise amplitude.

In some embodiments of the present disclosure, a capacitance value of the at least one bypass capacitor 500 exceeds a capacitance value of the resonant capacitor in any resonant circuit, that is, the capacitance value of the first bypass capacitor and/or the second bypass capacitor exceeds the capacitance value of the resonant capacitor in any resonant circuit, so as to ensure that the at least one bypass capacitor 500 only provides the DC bias and does not participate in the resonant of the resonant unit 300 as much as possible, thereby not changing the resonant frequency of the resonant unit as much as possible. In addition, the larger the capacitance value of the bypass capacitor 500, the better the filtering effect, and the better the ability to filter out the common mode noise.

In some embodiments of the present disclosure, when the input source of the three-phase resonant converter fails, in order to stabilize the output voltage of the three-phase resonant converter within a specific voltage range during a specified hold-up time, it is necessary to perform the leading phase-shifting control on the three-phase resonant converter. It should be noted that the leading phase-shifting control described in the present disclosure means that the secondary switch of the rectifier circuit on the secondary side of the three-phase resonant converter is activated before the primary switch of the primary circuit. Since the present solution needs to accurately control the conduction time of the primary switch and the secondary switch to achieve the leading conduction, it is necessary for the controlled secondary switch that needs to be leading to be a controllable switch (such as MOSFET, IGBT, etc.), and the secondary switch that does not need to be leading may be the controllable switch or an uncontrollable switch, such as a diode.

The three rectifier circuits (410, 420, 430) correspond respectively to the three primary switching bridge arms (110, 120, 130). Specifically, referring to FIG. 1 and FIG. 2, the rectifier circuit 410 corresponds to the primary switching bridge arm 110, the rectifier circuit 420 corresponds to the primary switching bridge arm 120, and the rectifier circuit 430 corresponds to the primary switching bridge arm 130. Further, each rectifier circuit includes a first rectifier switching unit and a second rectifier switching unit. At least one secondary switch of the first rectifier switching unit is activated before the first primary switch of the corresponding primary switching bridge arm by a first preset duration, and at least one secondary switch of the second rectifier switching unit is activated before the second primary switch of the corresponding primary switching bridge arm by the first preset duration. It should be noted that the first rectifier switching unit and the second rectifier switching unit in the present disclosure may have different forms depending on different structures of the rectifier circuit on the secondary side. In addition, those skilled in the art can understand that the first preset duration can be set as needed, and the specific value is not limited in embodiments of the present disclosure.

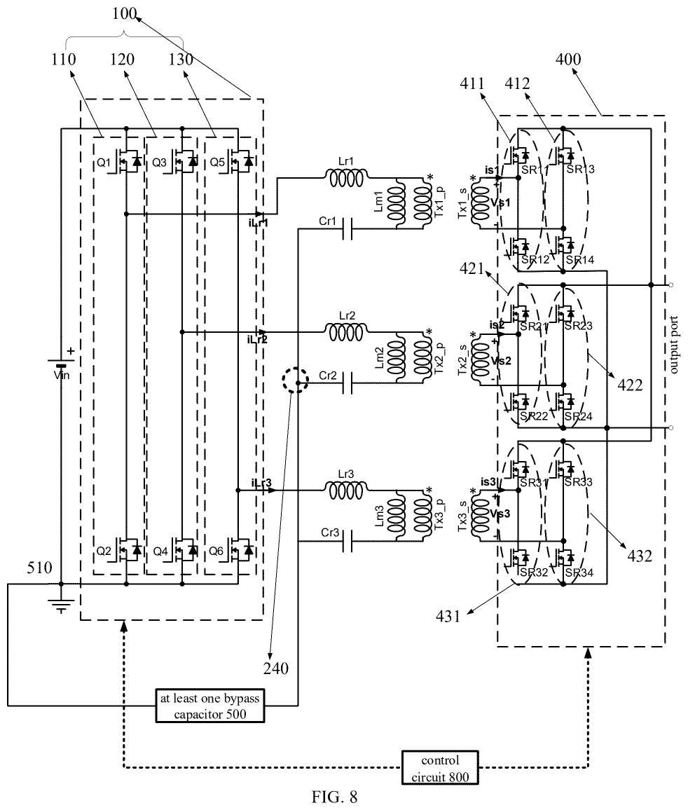

As shown in FIG. 8, the three-phase resonant converter in some embodiments of the present disclosure further includes: a control circuit 800, which is configured to control switching states of primary and secondary switches, and adjust the first preset duration to control the gain of the three-phase resonant converter. A resonant current of the resonant unit continuously increases during the first preset duration.

It should be noted that when the first rectifier switching unit is activated, a voltage across the secondary winding connected to the first rectifier switching unit is positive, and when the second rectifier switching unit is activated, a voltage across the secondary winding connected to the second rectifier switching unit is negative.

As shown in FIG. 8, the rectifier circuits (410, 420, 430) on the secondary side are full-bridge rectifier circuits, each of which includes a first secondary bridge arm and a second secondary bridge arm connected in parallel. The first secondary bridge arm includes a first secondary switch and a second secondary switch connected in series, and the second secondary bridge arm includes a third secondary switch and a fourth secondary switch connected in series, wherein the first secondary switch and the fourth secondary switch constitute the first rectifier switching unit, and the second secondary switch and the third secondary switch constitute the second rectifier switching unit. Therefore, when the first secondary switch and the fourth secondary switch are activated, the dotted terminal of the secondary winding is connected to the positive terminal of the output voltage, and the non-dotted terminal of the secondary winding is connected to the negative terminal of the output voltage, and accordingly, the voltage across the secondary winding is positive; and when the second secondary switch and the third secondary switch are activated, the dotted terminal of the secondary winding is connected to the negative terminal of the output voltage, and the non-dotted terminal is connected to the positive terminal of the output voltage, and accordingly, the voltage across the secondary winding is negative.

As shown in FIG. 2 and FIG. 8, the rectifier circuit 410 includes a first secondary bridge arm 411 and a second secondary bridge arm 412 connected in parallel. The first secondary bridge arm 411 includes a first secondary switch SR11 and a second secondary switch SR12 connected in series, and the second secondary bridge arm 412 includes a third secondary switch SR13 and a fourth secondary switch SR14 connected in series. The first secondary switch SR11 and the fourth secondary switch SR14 constitute the first rectifier switching unit of the rectifier circuit 410, and the second secondary switch SR12 and the third secondary switch SR13 constitute the second rectifier switching unit of the rectifier circuit 410. The rectifier circuit 420 includes a first secondary bridge arm 421 and a second secondary bridge arm 422 connected in parallel. The first secondary bridge arm 421 includes a first secondary switch SR21 and a second secondary switch SR22 connected in series, and the second secondary bridge arm 422 includes a third secondary switch SR23 and a fourth secondary switch SR24 connected in series. The first secondary switch SR21 and the fourth secondary switch SR24 constitute the first rectifier switching unit of the rectifier circuit 420, and the second secondary switch SR22 and the third secondary switch SR23 constitute the second rectifier switching unit of the rectifier circuit 420. The rectifier circuit 430 includes a first secondary bridge arm 431 and a second secondary bridge arm 432 connected in parallel. The first secondary bridge arm 431 includes a first secondary switch SR31 and a second secondary switch SR32 connected in series, and the second secondary bridge arm 432 includes a third secondary switch SR33 and a fourth secondary switch SR34 connected in series. The first secondary switch SR31 and the fourth secondary switch SR34 constitute the first rectifier switching unit of the rectifier circuit 430, and the second secondary switch SR32 and the third secondary switch SR33 constitute the second rectifier switching unit of the rectifier circuit 430.

In some embodiments of the present disclosure, the first secondary switch and the fourth secondary switch in the first rectifier switching unit are both activated before the first primary switch of the corresponding primary switching bridge arm by the first preset duration, and the second secondary switch and the third secondary switch in the second rectifier switching unit are both activated before the second primary switch of the corresponding primary switching bridge arm by the first preset duration.

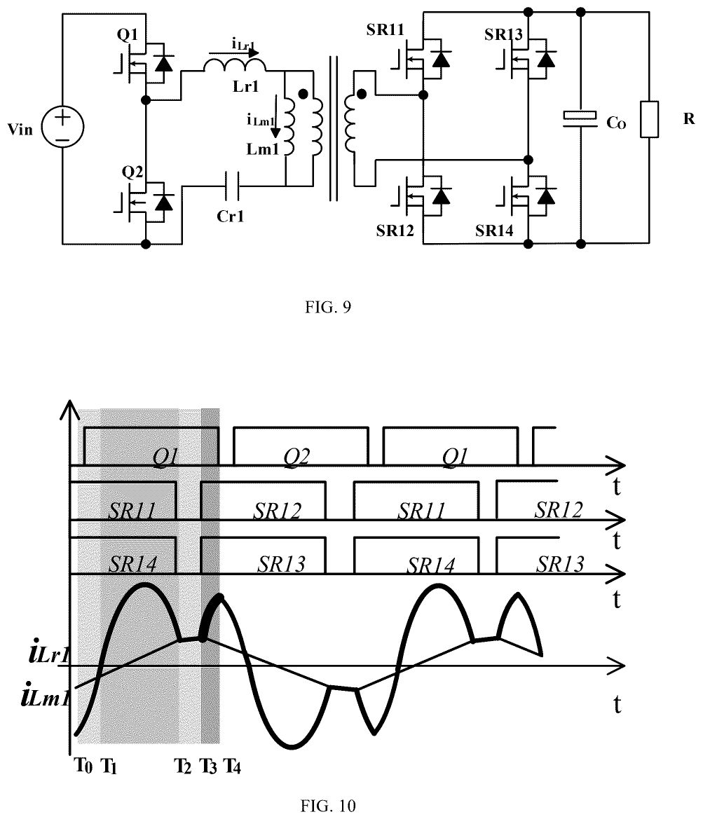

Specifically, a single phase circuit including the primary switching bridge arm 110 and the rectifier circuit 410 is taken as an example. FIG. 9 shows a simplified circuit diagram of a phase in the three-phase resonant converter provided by an embodiment of the present disclosure shown in FIG. 8. It can be understood by those skilled in the art that this figure only shows related devices, rather than a complete circuit structure, in order to illustrate the conduction timing between switches. FIG. 10 shows a conduction timing diagram of each switch included in FIG. 9. The first secondary switch SR11 and the fourth secondary switch SR14 are both activated before the first primary switch Q1 of the corresponding primary switching bridge arm 110 by the first preset duration, and the second secondary switch SR12 and the third secondary switch SR13 are both activated before the second primary switch Q2 of the corresponding primary switching bridge arm 110 by the first preset duration. It should be noted that the first primary switch Q1 and the second primary switch Q2 operate in an alternating conduction manner. Specifically, in a time period T0-T1, the first primary switch Q1, the first secondary switch SR11 and the fourth secondary switch SR14 are activated, the resonant current iLr1 is negative, and the resonant circuit provides energy to the output terminal. In a time period T1 to T2, an input voltage provides energy to the resonant circuit (the resonant inductor Lr and the resonant capacitor Cr) and the output terminal. In the secondary circuit, a secondary current starts from the secondary winding of the transformer, passes through the first secondary switch SR11, the output capacitor Co and the fourth secondary switch SR14 in sequence, and finally flows back to the secondary winding of the transformer. In this case, a voltage across the output capacitor Co is positive at the top and negative at the bottom, that is, when the first rectifier switching unit is activated, the voltage across the secondary winding of the transformer is positive. At time T2, the resonant current iLr1 drops to a level equal to an excitation current iLm1, no energy is transferred to the secondary side, the secondary current is zero, and the first secondary switch SR11 and the fourth secondary switch SR14 are deactivated. In a time period T3 to T4, the first primary switch Q1, the second secondary switch SR12 and the third secondary switch SR13 are activated. On the one hand, in the primary circuit, the input voltage provides energy to the resonant circuit (the resonant inductor Lr and the resonant capacitor Cr). On the other hand, in the secondary circuit, the secondary current starts from the positive terminal of the output capacitor, flows through the third secondary switch SR13, the secondary winding of the transformer, the second secondary switch SR12 in sequence, and finally flows back to the negative terminal of the output capacitor. At the time T3-T4, the dotted terminal of the secondary winding of the transformer is connected to the negative terminal of the output capacitor Co, and the non-dotted terminal of the secondary winding of the transformer is connected to the positive terminal of the output capacitor Co, that is, the voltage across the secondary winding of the transformer is negative. In other words, when the second rectifier switching unit is activated, the voltage across the secondary winding of the transformer is negative. Through such timing control, the output terminal can transfer energy to the transformer at the time T3 to T4, and then the energy is stored in the resonant circuit, that is, the energy is fed back from the output terminal to the resonant circuit. Obviously, it can be seen from FIG. 10 that by controlling the first secondary switch SR11 and the fourth secondary switch SR14 to be activated before the first primary switch Q1 of the corresponding primary switching bridge arm 110 by the first preset duration, and controlling the second secondary switch SR12 and the third secondary switch SR13 to be activated before the second primary switch Q2 of the corresponding primary switching bridge arm 110 by the first preset duration, the voltage of the secondary winding in the period T3 to T4 is reversed compared with that in the period T1 to T2, so that the energy at the output terminal is fed back to the resonant circuit at the primary side, and the input voltage also provides energy to the resonant circuit 310 during this period, so that more energy is provided to the resonant circuit 310 in the period T3 to T4, thereby increasing the resonant current i_{Lr1} and improving the output voltage gain, so as to ensure that when the input source fails, the output voltage can be stabilized within the specific voltage range during the specified hold-up time. Those skilled in the art will appreciate that the conduction timings of switches in the other two phases are similar to this, which will not be described in detail herein.

It should be noted that there is also a switch-conduction phase difference between individual phases of the primary switching unit 100 of the three-phase resonant converter, for example, it may be 120 degrees. Taking the three-phase resonant converter shown in FIG. 2 as an example, the primary switch Q1, the primary switch Q3 and the primary switch Q5 are activated at intervals of a preset time in sequence, and the preset time corresponds to the phase difference between individual phases. Similarly, the primary switch Q2, the primary switch Q4 and the primary switch Q6 are also activated at intervals of the same preset time in sequence. In addition, two primary switches on the same bridge arm operate in an alternating conduction manner.

It should be noted that, for the secondary side being the full-bridge rectifier circuit, referring to FIG. 1, a rectifier circuit of a phase is taken as an example to illustrate the timing of individual switches inside the full-bridge rectifier circuit. For example, the first secondary switch SR11 and the fourth secondary switch SR14 are synchronously turned on and off, and the second secondary switch SR12 and the third secondary switch SR13 are synchronously turned on and off. The first secondary switch SR11 and the second secondary switch SR12 are alternately turned on and off, and the third secondary switch SR13 and the fourth secondary switch SR14 are alternately turned on and off.

In some other embodiments of the present disclosure, referring to FIG. 8, FIG. 9 and FIG. 11, when the rectifier circuit on the secondary side is the full-bridge rectifier circuit, only the first secondary switch in the first rectifier switching unit is activated before the first primary switch of the corresponding primary switching bridge arm by the first preset duration, and only the second secondary switch in the second rectifier switching unit is activated before the second primary switch of the corresponding primary switching bridge arm by the first preset duration; or
only the fourth secondary switch in the first rectifier switching unit is activated before the first primary switch of the corresponding primary switching bridge arm by the first preset duration, and only the third secondary switch in the second rectifier switching unit is activated before the second primary switch of the corresponding primary switching bridge arm by the first preset duration.

In order to better illustrate this conduction timing, taking FIG. 9 as an example, only the fourth secondary switch SR14 in the first rectifier switching unit is activated before the first primary switch Q1 of the corresponding primary switching bridge arm 110 by the first preset duration, and only the third secondary switch SR13 in the second rectifier switching unit is activated before the second primary switch Q2 of the corresponding primary switching bridge arm 110 by the first preset duration. The conduction timing diagram of each switch is shown in FIG. 11. It can be seen that the first secondary switch SR11 is turned on or off synchronously with the first primary switch Q1, and the second secondary switch SR12 is turned on or off synchronously with the second primary switch Q2. It can be seen from FIG. 11 that the time period T0-T2 is the same as the process of the above embodiment, which will not be repeated here. In the time period T2-T3, the excitation current iLm1 is equal to the resonant current iLr1, and no energy is transferred to the secondary side. At time T3, the third secondary switch SR13 is turned on, and thereafter in the time period T3-T4, the secondary winding is short-circuited, and the input voltage is fully stored in the resonant circuit. Therefore, more energy is provided to the resonant circuit 310 during the time period T3 to T4, thereby increasing the resonant current i_{Lr1}, and improving the output voltage gain, so as to ensure that when the input source fails, the output voltage can be stabilized within the specific voltage range during the specified hold-up time. Those skilled in the art can understand that FIG. 11 is only an embodiment in which only the fourth secondary switch SR14 in the first rectifier switching unit is activated before the first primary switch Q1 of the corresponding primary switching bridge arm 110 by the first preset duration, and only the third secondary switch SR13 in the second rectifier switching unit is activated before the second primary switch Q2 of the corresponding primary switching bridge arm 110 by the first preset duration, without limiting the turn-on or turn-off time of the non-leading first secondary switch SR11 and second secondary switch SR12. In this case, the first secondary switch SR11 and the second secondary switch SR12 only play a synchronous rectification role. If the first secondary switch SR11 and the second secondary switch SR12 are not turned on, they will not affect the circuit operation. If the first secondary switch SR11 and the second secondary switch SR12 are turned on, they should be turned off before the secondary current reversal, otherwise a hard turn-off will occur. For example, it is also possible to control the first secondary switch SR11 to turn off with a delay relative to the first primary switch Q1, and control the second secondary switch SR12 to turn off with a delay relative to the second primary switch Q2, and the first secondary switch SR11 and the second secondary switch SR12 should be turned off before the resonant current drops to a level equal to the excitation current again. Therefore, the setting is carried out according to control needs, which is not used to limit the protection scope of embodiments of the present disclosure.

In some embodiments of the present disclosure, the rectifier circuits (410, 420, 430) on the secondary side can be each a full-wave rectifier circuit with a center tap, and each rectifier circuit includes a fifth secondary switch and a sixth secondary switch. The first rectifier switching unit is composed of the fifth secondary switch, and the second rectifier switching unit is composed of the sixth secondary switch.

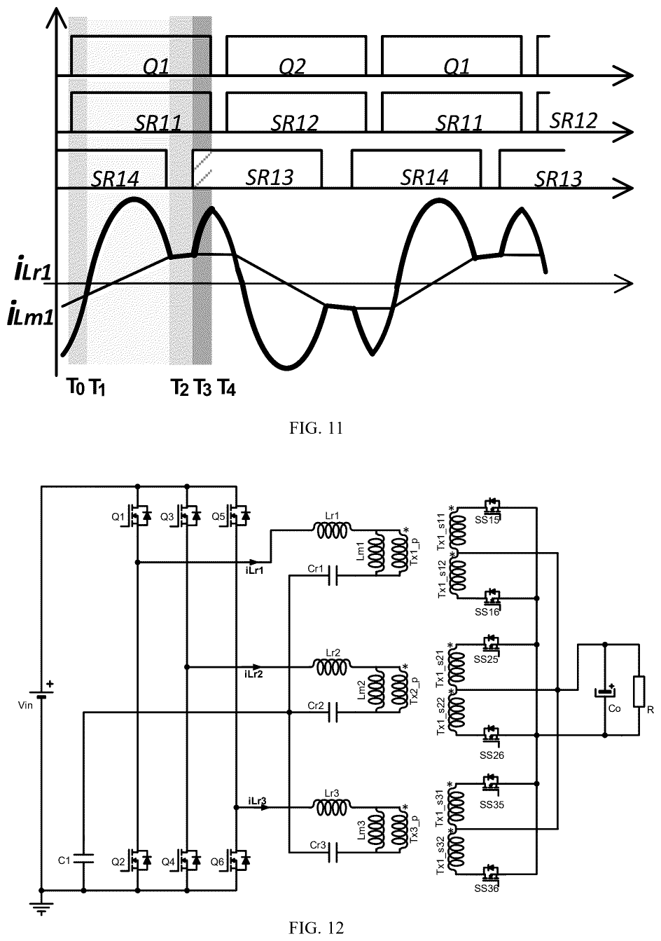

As shown in FIG. 12, it is a circuit diagram when a rectifier circuit (410, 420, 430) of an embodiment of the present disclosure is a full-wave rectifier circuit with a center tap. Specifically, the rectifier circuit 410 includes a fifth secondary switch SS15 and a sixth secondary switch SS16, the first rectifier switching unit of the rectifier circuit 410 includes the fifth secondary switch SS15, and the second rectifier switching unit of the rectifier circuit 410 includes the sixth secondary switch SS16. The rectifier circuit 420 includes a fifth secondary switch SS25 and a sixth secondary switch SS26, the first rectifier switching unit of the rectifier circuit 420 includes the fifth secondary switch SS25, and the second rectifier switching unit of the rectifier circuit 420 includes the sixth secondary switch SS26. The rectifier circuit 430 includes a fifth secondary switch SS35 and a sixth secondary switch SS36, the first rectifier switching unit of the rectifier circuit 430 includes the fifth secondary switch SS35, and the second rectifier switching unit of the rectifier circuit 430 includes the sixth secondary switch SS36.

It should be noted that, in each rectifier circuit, the fifth secondary switch and the sixth secondary switch operate in an alternating conduction manner. For example, in the rectifier circuit 410, the fifth secondary switch SS15 and the sixth secondary switch SS16 operate in an alternating conduction manner; in the rectifier circuit 420, the fifth secondary switch SS25 and the sixth secondary switch SS26 operate in an alternating conduction manner and in the rectifier circuit 430, the fifth secondary switch SS35 and the sixth secondary switch SS36 operate in an alternating conduction manner.

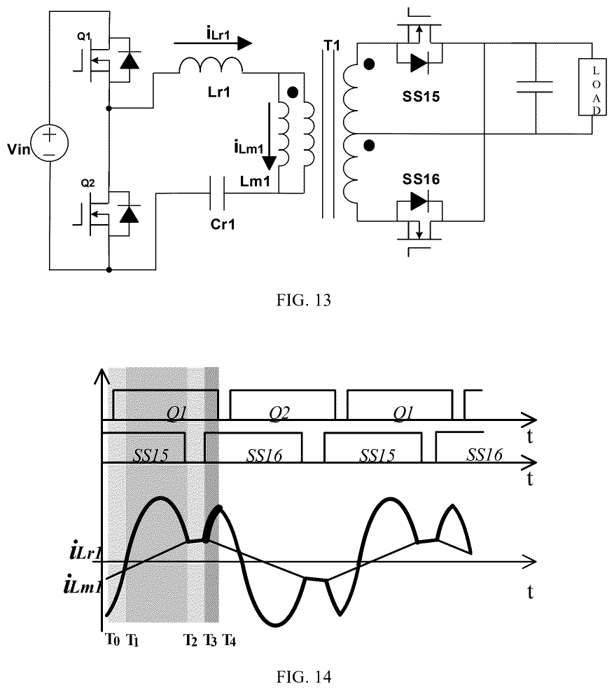

In the above embodiments of the present disclosure, in each rectifier circuit, the fifth secondary switch in the first rectifier switching unit is activated before the first primary switch of the corresponding primary switching bridge arm by the first preset duration, and the sixth secondary switch in the second rectifier switching unit is activated before the second primary switch of the corresponding primary switching bridge arm by the first preset duration. Specifically, taking a phase including the primary switching bridge arm 110 and the rectifier circuit 410 as an example, FIG. 13 is a simplified circuit diagram of a phase in the three-phase resonant converter provided by an embodiment of the present disclosure shown in FIG. 12. It can be understood by those skilled in the art that this figure only shows related devices, rather than a complete circuit structure, in order to illustrate the conduction timing between switches. FIG. 14 is a conduction timing diagram of each switch included in FIG. 13, the fifth secondary switch SS15 is activated before the first primary switch Q1 of the corresponding primary switching bridge arm 110 by the preset duration, and the sixth secondary switch SS16 is activated before the second primary switch Q2 of the corresponding primary switching bridge arm 110 by the first preset duration. In addition, the first primary switch Q1 and the second primary switch Q2 operate in an alternating conduction manner, and the fifth secondary switch SS15 and the sixth secondary switch SS16 operate in an alternating conduction manner. As can be seen from FIG. 14, by controlling the fifth secondary switch SS15 to activate before the first primary switch Q1 of the corresponding primary switching bridge arm 110 by the first preset duration, and controlling the sixth secondary switch SS16 to activate before the second primary switch Q2 of the corresponding primary switching bridge arm 110 by the first preset duration, more energy is fed back from the secondary side to the resonant circuit 310 during the period from T3 to T4, thereby increasing the resonant current i_{Lr1}, and then increasing the output voltage gain, so as to ensure that when the input source fails, the output voltage can be stabilized within the specific voltage range during the specified hold-up time. Those skilled in the art will appreciate that the conduction timings of switches in the other two phases are similar to this, which will not be described in detail herein.

It should be noted that in each rectifier circuit, any secondary switch activated before the first primary switch and the secondary switch activated before the second primary switch are deactivated before the resonant current of the resonant unit drops to a level equal to the excitation current, thereby achieving soft-turn off. If it is turned off after the resonant current drops to a level equal to the excitation current, the hard-turn off will be caused due to the current backflow.

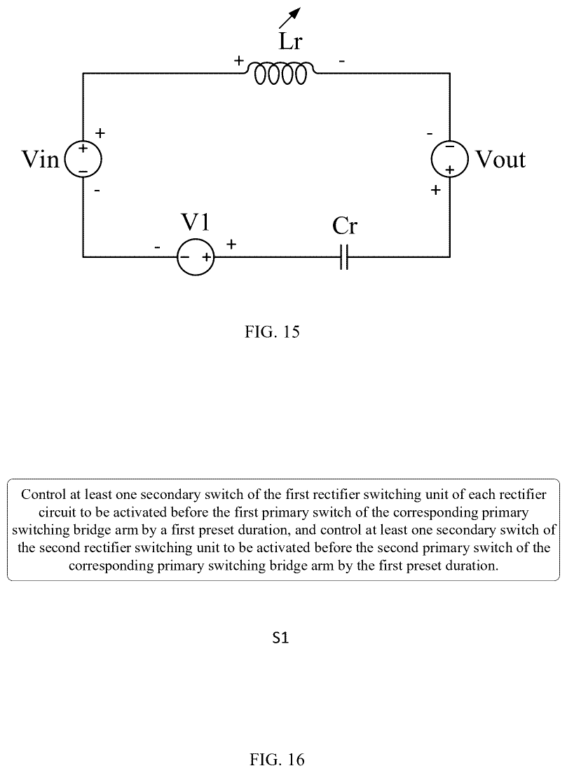

It should be noted that, as shown in FIG. 15, which is a simplified analysis topology diagram of a single-phase circuit of the three-phase resonant converter shown in FIG. 1, as seen, if it is desired to increase the resonant current i_{Lr}, since a voltage V1 of the common node 240 is in opposite phase to the input voltage, the smaller V1 is, the more energy the resonant circuit (resonant inductor Lr and resonant capacitor Cr) can accumulate. When the common node 240 is not connected to the bypass circuit, the voltage V1 of the common node 240 is floating and has a very high AC component. In embodiments of the present disclosure, the bypass capacitor is provided between the common node 240 and the input terminal of the primary switching unit 100 (for example, the positive terminal and/or the negative terminal of the input voltage), and the high-frequency component in the voltage of the common node 240 is partially filtered out by the bypass capacitor to reduce the voltage fluctuation of the common node 240. Therefore, during the period T3 to T4, the voltage V1 of the common node 240 has a reduced amplitude compared to that when the bypass capacitor is not connected, allowing the resonant inductor Lr to receive a higher voltage, which is conducive to increasing the resonant current i_{Lr} and further facilitating the realization of the leading phase-shifting control. In other words, the larger the capacitance value of the bypass capacitor 500, the better the filtering effect, the more it can reduce the fluctuation of the voltage V1 of the common node 240, and the more it is conducive to the realization of the leading phase-shifting control, thereby effectively extending the hold-up time for the output voltage of the converter to be stable within the specific voltage range when the input source fails.

It should be noted that the three-phase resonant converter provided in the embodiment of the present disclosure also has a current sharing characteristic. When the common node is not connected to any component, a traditional three-phase LLC resonant converter is formed, which has the current sharing characteristic. In embodiments of the present disclosure, the bypass capacitor is in series with the common node, which still retains a certain current sharing characteristic compared to the three-phase half-bridge LLC parallel resonant converter formed by directly connecting the common node 240 to the ground terminal.

FIG. 16 is a schematic diagram of a method for controlling a three-phase resonant converter disclosed in the present disclosure, which is applicable to the aforementioned three-phase resonant converter. The method S1 includes:
controlling at least one secondary switch of the first rectifier switching unit of each rectifier circuit to be activated before the first primary switch of the corresponding primary switching bridge arm by a first preset duration, and controlling at least one secondary switch of the second rectifier switching unit to be activated before the second primary switch of the corresponding primary switching bridge arm by the first preset duration.

By controlling the secondary switch in the rectifier circuit to be activated before the corresponding primary switch in the primary switching bridge arm, the resonant current i_{Lr1} increases, thereby improving the output voltage gain to ensure that when the input source fails, the output voltage can be maintained within the specific voltage range for a period of time.

In some embodiments of the present disclosure, the method further includes:
adjusting the first preset duration to control the gain of the three-phase resonant converter, wherein a resonant current of the resonant unit continuously increases during the first preset duration.

In some embodiments of the present disclosure, the method further includes:
controlling the secondary switch activated before the first primary switch and the secondary switch activated before the second primary switch to deactivate before the resonant current of the resonant unit drops to a level equal to an excitation current.

In some embodiments of the present disclosure, the method further includes:
controlling a first primary switch and a second primary switch of the same primary switching bridge arm to operate in an alternating conduction manner, and controlling first primary switches of different primary switching bridge arms to operate in a phase-shifted manner.

As seen, in the three-phase resonant converter and the control method thereof provided by the present disclosure, by providing the at least one bypass capacitor between the common node and the input terminal of the primary switching unit, the potential of the common node is effectively reduced, thereby facilitating the realization of the leading phase-shifting control on the three-phase resonant converter. In addition, providing the bypass capacitor can also change the flow path of the common mode noise, so that the common mode noise has the higher frequency and the lower amplitude, and is easier to be filtered out. In addition, the present disclosure can also provide the three-phase resonant converter with the current sharing characteristic, which has high efficiency and reliability and lower cost. Finally, by performing the leading phase-shifting control on the switch in the rectifier unit on the secondary side and adjusting the leading time by using the controller, the gain of the three-phase resonant converter can be adjusted, thereby ensuring that the output voltage of the three-phase resonant converter can be maintained within the specific voltage range for a period of time when the input source fails. Compared with the three-phase resonant converter structure in the prior art, the technical advantages of the present disclosure are very obvious.

Those skilled in the art will appreciate that although several modules or units are mentioned in the above description, such division of modules or units is not mandatory. In fact, features and functions of two or more of the modules or units described above may be embodied in one module or unit in accordance with embodiments of the present disclosure. Alternatively, the features and functions of one module or unit described above may be further divided into multiple modules or units.

Other embodiments of the present disclosure will be apparent to those skilled in the art from consideration of the specification and practice of the present disclosure disclosed herein. The present application is intended to cover any variations, uses, or adaptations of the present disclosure, which are in accordance with the general principles of the present disclosure and include common general knowledge or conventional technical means in the art that are not disclosed in the present disclosure. The specification and embodiments are illustrative, and the real scope and spirit of the present disclosure is defined by the appended claims.

What is claimed is:

1. A three-phase resonant converter, comprising:
a primary switching unit, comprising three primary switching bridge arms connected in parallel, wherein each primary switching bridge arm comprises a first primary switch and a second primary switch connected in series, and a bridge arm midpoint formed between the first primary switch and the second primary switch;
a voltage conversion unit, comprising three primary windings and three secondary windings, wherein a first terminal of each primary winding is electrically connected to the bridge arm midpoint of the corresponding primary switching bridge arm, and second terminals of the three primary windings are electrically connected to a common node;
a resonant unit, comprising three resonant circuits, wherein each resonant circuit comprises a resonant inductor and a resonant capacitor, and each primary winding of the voltage conversion unit is connected in series with the resonant inductor and the resonant capacitor of the corresponding resonant circuit;
a secondary rectifier unit, comprising three rectifier circuits with output terminals connected in parallel, wherein each input terminal of the three rectifier circuits is electrically connected to a respective secondary winding; and
at least one bypass capacitor, electrically connected between the common node and an input terminal of the primary switching unit.

2. The three-phase resonant converter according to claim 1, wherein the at least one bypass capacitor comprises a first bypass capacitor, a first terminal of the first bypass capacitor is electrically connected to the common node, and a second terminal of the first bypass capacitor is electrically connected to the input terminal of the primary switching unit.

3. The three-phase resonant converter according to claim 2, wherein the at least one bypass capacitor further comprises a second bypass capacitor, a first terminal of the second bypass capacitor is electrically connected to the common node, and a second terminal of the second bypass capacitor is electrically connected to another input terminal of the primary switching unit.

4. The three-phase resonant converter according to claim 1, wherein the three rectifier circuits correspond respectively to the three primary switching bridge arms, each rectifier circuit comprises a first rectifier switching unit and a second rectifier switching unit, wherein at least one secondary switch of the first rectifier switching unit is activated before the first primary switch of the corresponding primary switching bridge arm by a first preset duration, and at least one secondary switch of the second rectifier switching unit is activated before the second primary switch of the same primary switching bridge arm by the first preset duration.

5. The three-phase resonant converter according to claim 4, further comprising:
a control circuit, configured to adjust the first preset duration in order to control the gain of the three-phase resonant converter, wherein a resonant current of the resonant unit continuously increases during the first preset duration.

6. The three-phase resonant converter according to claim 4, wherein when the first rectifier switching unit is activated, a voltage across the secondary winding connected to the first rectifier switching unit is positive; when the second rectifier switching unit is activated, a voltage across the secondary winding connected to the second rectifier switching unit is negative.

7. The three-phase resonant converter according to claim 4, wherein the rectifier circuit is a full-bridge rectifier circuit, comprising a first secondary bridge arm and a second secondary bridge arm connected in parallel, the first secondary bridge arm comprises a first secondary switch and a second secondary switch connected in series, the second secondary bridge arm comprises a third secondary switch and a fourth secondary switch connected in series, the first rectifier switching unit is constituted by the first secondary switch and the fourth secondary switch, and the second rectifier switching unit is constituted by the second secondary switch and the third secondary switch.

8. The three-phase resonant converter according to claim 7, wherein the first secondary switch and the fourth secondary switch of the first rectifier switching unit are activated before the first primary switch of the corresponding primary switching bridge arm by the first preset duration, and the second secondary switch and the third secondary switch of the second rectifier switching unit are activated before the second primary switch of the corresponding primary switching bridge arm by the first preset duration.

9. The three-phase resonant converter according to claim 7, wherein only the first secondary switch of the first rectifier switching unit is activated before the first primary switch of the corresponding primary switching bridge arm by the first preset duration, and only the second secondary switch of the second rectifier switching unit is activated before the second primary switch of the corresponding primary switching bridge arm by the first preset duration; or
only the fourth secondary switch of the first rectifier switching unit is activated before the first primary switch of the corresponding primary switching bridge arm by the first preset duration, and only the third secondary switch of the second rectifier switching unit is activated before the second primary switch of the corresponding primary switching bridge arm by the first preset duration.

10. The three-phase resonant converter according to claim 4, wherein the rectifier circuit is a full-wave rectifier circuit with a center tap, comprising a fifth secondary switch and a sixth secondary switch, the first rectifier switching unit is constituted by the fifth secondary switch, and the second rectifier switching unit is constituted by the sixth secondary switch.

11. The three-phase resonant converter according to claim 4, wherein the secondary switch activated before the first primary switch and the secondary switch activated before the second primary switch are deactivated before a resonant current of the resonant unit drops to a level equal to an excitation current.

12. The three-phase resonant converter according to claim 1, wherein the first primary switch and the second primary switch of the same primary switching bridge arm operate in an alternating conduction manner, while the first primary switches of different primary switching bridge arms operate in a phase-shifted manner.

13. The three-phase resonant converter according to claim 1, wherein a capacitance value of the at least one bypass capacitor exceeds a capacitance value of the resonant capacitor in any resonant circuit.

14. A method for controlling a three-phase resonant converter, wherein the three-phase resonant converter comprises:
a primary switching unit, comprising three primary switching bridge arms connected in parallel, wherein each primary switching bridge arm comprises a first primary switch and a second primary switch connected in series, and a bridge arm midpoint formed between the first primary switch and the second primary switch;
a voltage conversion unit, comprising three primary windings and three secondary windings, wherein a first terminal of each primary winding is electrically connected to the bridge arm midpoint of the corresponding primary switching bridge arm, and second terminals of the three primary windings are electrically connected to a common node;
a resonant unit, comprising three resonant circuits, wherein each resonant circuit comprises a resonant inductor and a resonant capacitor, and each primary winding of the voltage conversion unit is connected in series with the resonant inductor and the resonant capacitor of the corresponding resonant circuit;
a secondary rectifier unit, comprising three rectifier circuits with output terminals connected in parallel, wherein each input terminals of the three rectifier circuits is electrically connected to a respective three secondary windings, and each rectifier circuit comprises a first rectifier switching unit and a second rectifier switching unit; and
at least one bypass capacitor, electrically connected between the common node and an input terminal of the primary switching unit;
the method comprises:
controlling at least one secondary switch of the first rectifier switching unit of each rectifier circuit to be activated before the first primary switch of the corresponding primary switching bridge arm by a first preset duration, and controlling at least one secondary switch of the second rectifier switching unit to be activated before the second primary switch of the corresponding primary switching bridge arm by the first preset duration.

15. The method according to claim 14, further comprising:
adjusting the first preset duration to control the gain of the three-phase resonant converter, wherein a resonant current of the resonant unit continuously increases during the first preset duration.

16. The method according to claim 14, further comprising:
controlling the secondary switch activated before the first primary switch and the secondary switch activated before the second primary switch to deactivate before a resonant current of the resonant unit drops to a level equal to an excitation current.

17. The method according to claim 14, further comprising:
controlling the first primary switch and the second primary switch of the same primary switching bridge arm to operate in an alternating conduction manner, and controlling the first primary switches of different primary switching bridge arms to operate in a phase-shifted manner.
